(19) United States
(12) Patent Application Publication
(10) Pub. No.: US 2022/0115845 A1
(43) Pub. Date: Apr. 14, 2022

(54) BOX WITH WATERPROOF CABLE HOLE STRUCTURE

(71) Applicant: Yen-Chiu Chang, Taipei (TW)

(72) Inventor: Yen-Chiu Chang, Taipei (TW)

(21) Appl. No.: 17/068,861

(22) Filed: Oct. 13, 2020

(51) Int. Cl. H02B 1/28; H02B 1/46

(52) U.S. Cl. CPC H02B 1/28; H02B 1/46

(57) ABSTRACT

A box with waterproof cable hole structure includes a lower case, a pressing block, an electricity cable, and a upper cover. The lower case includes an accommodating space defined therein and an opening connecting the accommodating space. A notch is formed on an edge of the opening, the notch has a lower pressing surface, and a lower cable groove is formed on the lower pressing surface. The pressing block is embedded into the notch. The pressing block further includes an upper pressing surface combined with the lower pressing surface, and the upper pressing surface includes an upper cable groove combined with the lower cable groove to form a cable hole. The electricity cable passes through the cable hole and is pressed between the upper pressing surface and the lower pressing surface. The upper cover is configured to be combined with the lower case to seal the opening.

### BACKGROUND

### Technical Field

This disclosure relates to waterproof for a case or a box, in particular, to a box with waterproof cable hole structure.

### Related Art

For the electricity cable arrangement, the case of a battery box, a control box, or the other power supply devices must have cable holes. These cable holes form channels for water to pass through, so that additional waterproofing measures are required.

In order to thread electricity cable, the hole diameter of the cable hole needs to be larger than that of the electricity cable. After that, glue is fed to seal the gap, or a rubber sleeve covering the electricity cable is squeezed into the gap to seal. The fed glue usually forms unsightly residues on the case. The operation of squeezing the rubber sleeve into the gap is not easy to operate and affects the assembly speed.

In addition, whether it is threading the electricity cable, feeding the glue, or installing the rubber sleeve, it is not conducive to the use of automated machinery. It completely relies on manpower, which makes the overall manpower cost high and productivity is not easy to increase.

### SUMMARY

In view of the foregoing problem, this disclosure discloses a box with waterproof cable hole structure which can be assembled quickly and achieves a good waterproof effect.

This disclosure discloses a box with waterproof cable hole structure includes a lower case, a pressing block, an electricity cable, and a upper cover. The lower case includes an accommodating space defined therein and an opening connecting the accommodating space. A notch is formed on an edge of the opening. The notch has a lower pressing surface in parallel to the edge of the opening. A lower cable groove is formed on the lower pressing surface and connects the accommodating space and an outer surface of the lower case. The pressing block is configured to be embedded into the notch, and the pressing block includes a front side surface and a rear side surface respectively corresponding to the outer surface and the accommodating space. The pressing block further includes an upper pressing surface configured to be combined with the lower pressing surface, and the upper pressing surface includes an upper cable groove configured to be combined with the lower cable groove to form a cable hole. The electricity cable includes an external end and an internal end. The electricity cable passes through the cable hole and is pressed between the upper pressing surface and the lower pressing surface. The internal end is located within the accommodating space and the external end is located outside the lower case. The upper cover is configured to be combined with the lower case to seal the opening.

In at least one embodiment, the box with waterproof cable hole structure further includes a glue bulk partially filled in the accommodating space and covering a connection between the electricity cable and the cable hole.

In at least one embodiment, the lower case further includes a glue trough located in the accommodating space and surrounding the connection between the electricity cable and the cable hole, and the glue bulk is filled in the glue trough.

In at least one embodiment, the lower case further includes an auxiliary cable groove located on an edge of the glue trough, for hanging the electricity cable thereon, such that the internal end is located outside the glue trough.

In at least one embodiment, the lower case further includes a cable seat disposed in the glue trough, the pressing block further a protruding portion protruding from the rear side surface, and the protruding portion is configured to press the electricity cable on the cable seat.

In at least one embodiment, the pressing block includes two embedding wings arranged opposite to each other and extending from edges of the rear side surface.

In at least one embodiment, the lower case further includes two embedding grooves arranged opposite to each other and located at the notch, and the embedding wings are configured to be embedded into the embedding grooves respectively.

In at least one embodiment, the pressing block includes two embedding wings arranged opposite to each other and located between the front side surface and the rear side surface, the lower case further includes two embedding grooves arranged opposite to each other and located at the notch, and the embedding wings are configured to be embedded into the embedding grooves respectively.

In at least one embodiment, the box with waterproof cable hole structure further includes a sealant ring, arranged to surround the opening and to be pressed between the upper cover and the lower case.

In at least one embodiment, the upper cover further includes a collar configured to press the sealant ring.

In this disclosure, the electricity cable can be easily placed in the notch. And then the pressing block is embedded into the notch to press the electricity cable. The electricity cable and the inner wall of the cable hole can contact each other to achieve a good waterproof effect. Therefore, it is not required to dispense glue on the outside of the lower case to affect the appearance of the box. And the configuration of the above structure is conducive to the rapid production of automated machinery. In at least one embodiment, The lower case is provided with a glue trough for filling the glue bulk, The glue bulk further seals the cable hole from the inside of the lower case, and at the same time the glue bulk further fixes the electricity cable, so that the electricity cable is able to withstand pulling force.

### BRIEF DESCRIPTION OF THE DRAWINGS

This disclosure will become more fully understood from the detailed description given herein below for illustration only, and thus not limitative of this disclosure, wherein:

FIG. 1 is an exploded view of a box with waterproof cable hole structure according to an embodiment of this disclosure;

FIG. 2 is another exploded view of the box with waterproof cable hole structure according to the embodiment of this disclosure;

FIG. 3 is perspective view of the box with waterproof cable hole structure according to the embodiment of this disclosure;

FIG. 4 is a front view of the box with waterproof cable hole structure according to the embodiment of this disclosure;

FIG. 5 is a top view of a lower case according to the embodiment of this disclosure;

FIG. 6 is a partial top view of the lower case according to the embodiment of this disclosure;

FIG. 7 is a partial top view illustrating the lower case, an electricity cable and a pressing block according to the embodiment of this disclosure;

FIG. 8 is a partial top view illustrating the lower case, an electricity cable, a pressing block, and a glue bulk according to the embodiment of this disclosure;

FIG. 9 is a partial top view of the lower case according to a modification of this disclosure; and

FIG. 10 is a partial top view illustrating the lower case, the electricity cable and the pressing block according to the modification of this disclosure.

### DETAILED DESCRIPTION

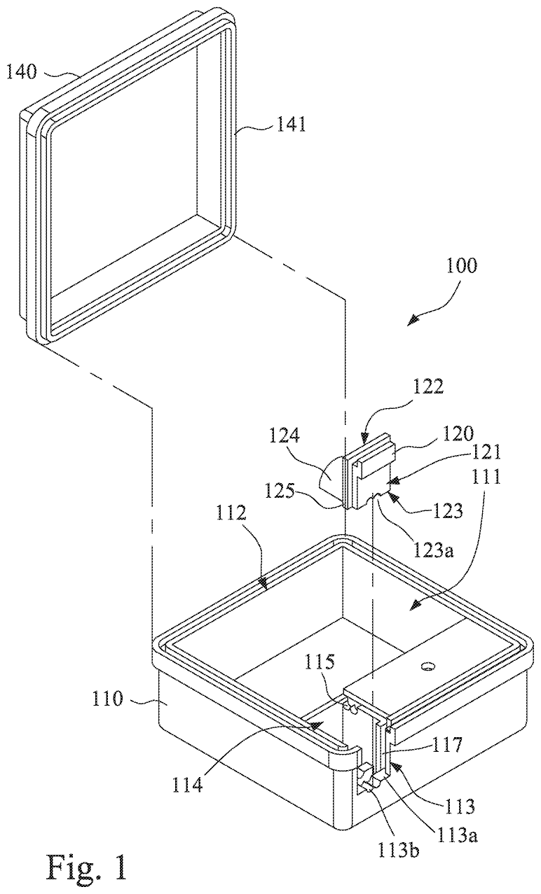

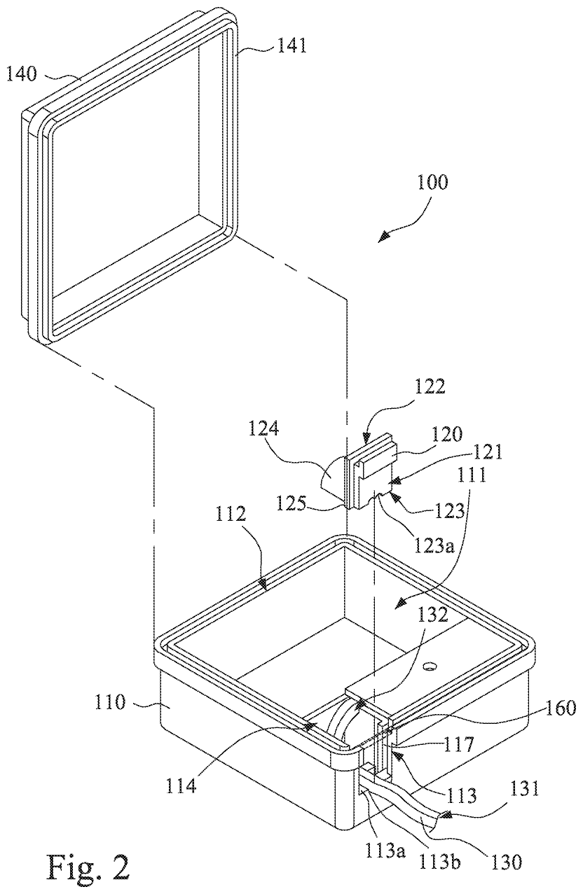

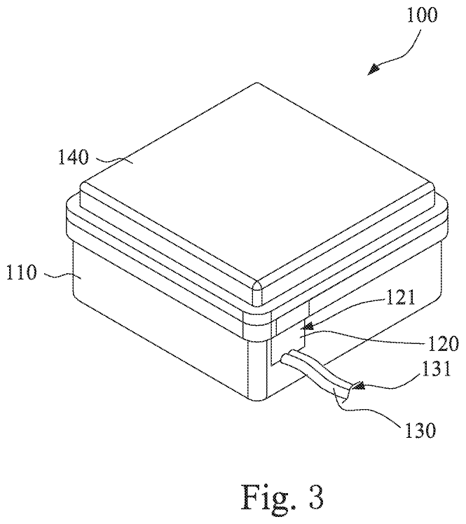

FIG. 1, FIG. 2, and FIG. 3 illustrate a box 100 with waterproof cable hole structure according to an embodiment of this disclosure, which includes a lower case 110, a pressing block 120, an electricity cable 130, and an upper cover 140. The box 100 may be, but is not limited to, a battery box or a control box of a light string which need to be waterproof, and need to be provided with the electricity cable 130 extending from the inside to the outside.

As shown in FIG. 1, FIG. 2, and FIG. 3, the lower case 110 includes an accommodating space 111 defined therein and an opening 112 connecting the accommodating space 111. A notch 113 is formed on an edge of the opening 112. The notch 113 has a lower pressing surface 113a in parallel to the edge of the opening 112. One or more lower cable grooves 113b are formed on the lower pressing surface 113a and connect the accommodating space 111 and an outer surface of the lower case 110.

As shown in FIG. 1, FIG. 2, and FIG. 3, the pressing block 120 is configured to be embedded into the notch 113. The pressing block 120 includes a front side surface 121 and a rear side surface 122 respectively corresponding to the outer surface and the accommodating space 111. The pressing block 120 includes an upper pressing surface 123 configured to combined with the lower pressing surface 113a. The upper pressing surface 123 includes one or more upper cable grooves 123a configured to be combined with the lower cable grooves 113b to form a cable hole.

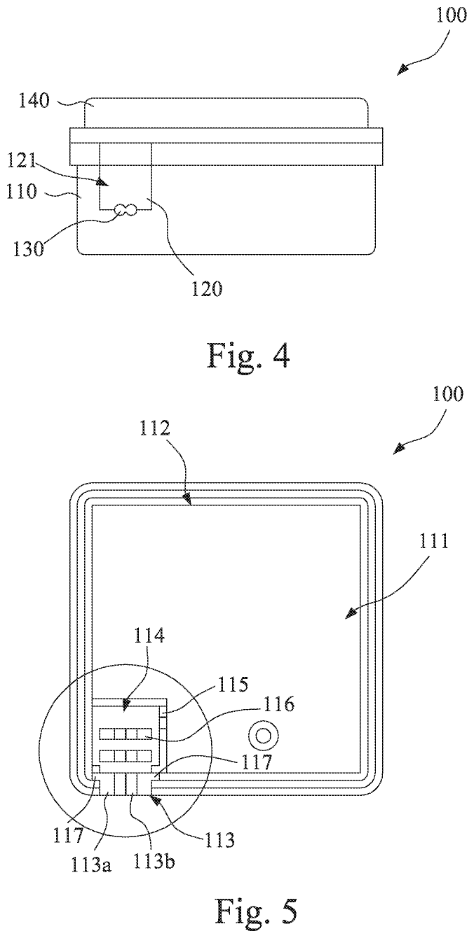

As shown in FIG. 1, FIG. 2, FIG. 3 and FIG. 4, the electricity cable 130 includes an external end 131 and an internal end 132. The electricity cable 130 passes through the cable hole and is pressed between the upper pressing surface 113a and the lower pressing surface 123. The internal end 132 is located within the accommodating space 111 and the external end 131 is located outside the lower case 110. In particular, in this embodiment, the electricity cable 130 includes a wire insulation layer and one or more metal cores. A rubber or plastic wire insulation layer has a certain degree of elasticity. When the pressing block 120 is embedded into the notch 113, and the electricity cable 130 is pressed between the upper pressing surface 113a and the lower pressing surface 123, walls of the upper cable groove 123a and the lower cable groove 113b contact the wire insulation layer, to provide good sealing effect. The number of the upper cable grooves 123a or the lower cable grooves 113b, that is, the number of the cable holes, is mainly determined by the number of the metal cores of the electricity cable 130. For example, the electricity cable 130 shown in the drawings has two metal cores; therefore, the number of the upper cable grooves 123a or the lower wire grooves 113b, that is, the number of the cable holes can be two.

In particular, in this embodiment, as shown in FIG. 2 and FIG. 3, the steps of assembling the box 100 are from top to bottom. Firstly, the electricity cable 130 is placed in the upper cable groove 123a, and the routing of the electricity cable 130 is properly arranged, then the pressing block 120 is embedded into the notch 113 to press the cable 130, the assembling for the waterproof threading structure is quickly completed. This assembling method is conducive to the use of automated equipment for assembling the box 100 to increase productivity. And it is not required to feed glue at the outlet of the cable hole or insert a watertight rubber block at the outlet of the cable hole, and the appearance of the box 100 can be more smoother.

As shown in FIG. 1, FIG. 2, FIG. 3 and FIG. 4, The upper cover 140 is configured to be combined with the lower case 110 to seal the opening 112. The upper cover 140 may be pivotally connected to the lower case 110, and then fixed by latches; or the upper cover 140 may be directly fixed to the lower case 110 by latches; or the upper cover 140 may be adhered to the lower case 110. The fixing between the upper cover 140 and the lower case 110 may be detachable or permanent, and is determined according to the purpose of the box 100. When the box 100 is used as a battery box, the fixation between the upper cover 140 and the lower housing 110 can be detachable. When the box 100 is used as a control box, the fixation between the upper cover 140 and the lower case 110 can be permanent.

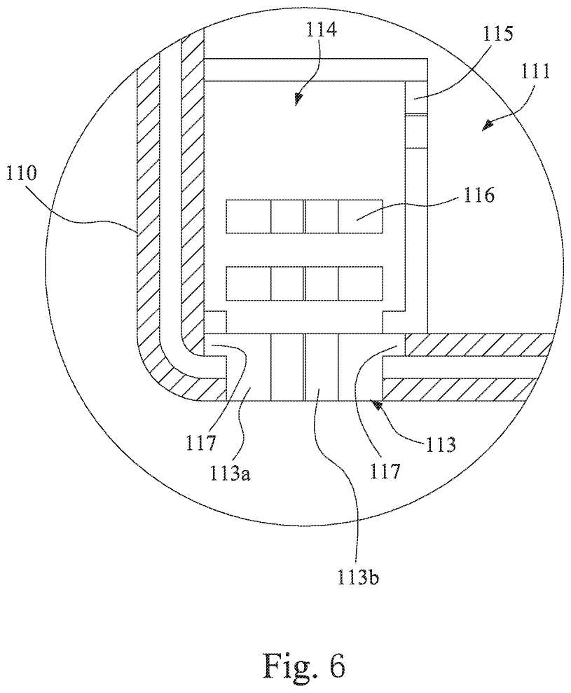

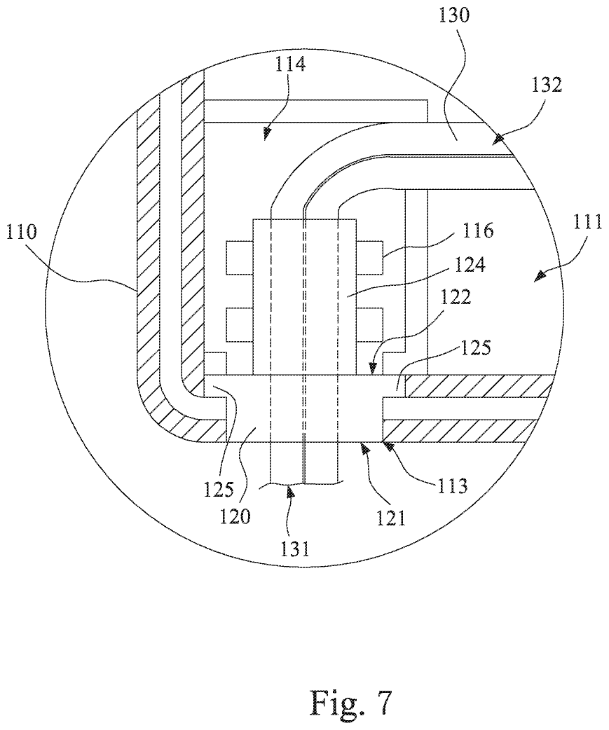

As shown in FIG. 5, FIG. 6, and FIG. 7, the lower case 110 further includes a glue trough 114. The glue trough 114 is located in the accommodating space 111 and surrounds the notch 113, so as to isolate the notch 113 and other parts of the accommodating space 111; that is, the glue trough 114 surrounds the connection between the electricity cable 130 and the cable hole. the lower case 110 further includes an auxiliary cable groove 115 located on an edge of the glue trough 114, for hanging the electricity cable thereon, such that the internal end 132 is located outside the glue trough 114.

As shown in FIG. 5, FIG. 6, and FIG. 7, the lower case 110 further includes one more cable seats 116 disposed in the glue trough 114, the pressing block 120 further a protruding portion 124 protruding from the rear side surface 122. The protruding portion 124 is configured to press the electricity cable 130 on the cable seat 116. Such that at least a part of the electricity cable 130 is fixed in the glue trough 114.

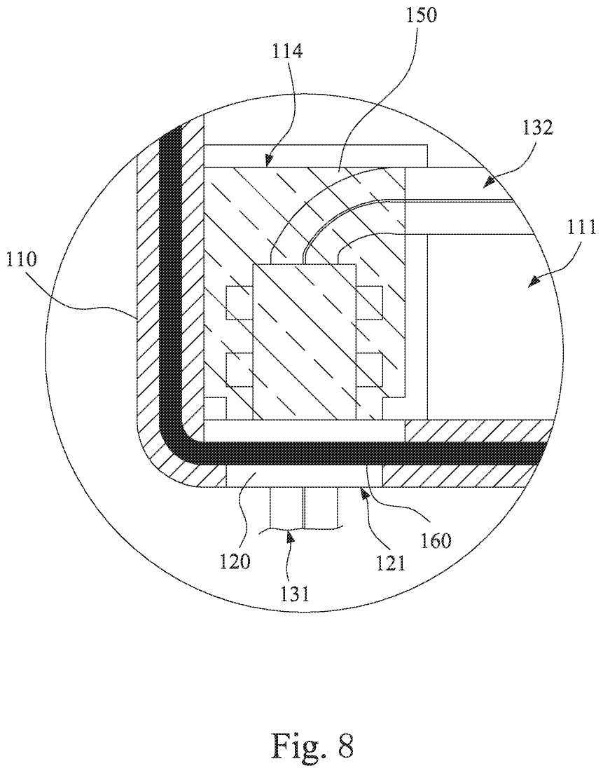

As shown in FIG. 8, the box 100 with waterproof cable hole structure further includes a glue bulk 150, partially filled in the accommodating space 111, in particular the glue bulk 150 is filled in the glue trough 114 to prevent the glue bulk 150 from flowing randomly. The glue bulk 150 covers a connection between the electricity cable 130 and the cable hole.

The glue bulk 150 may further covers cable seats 116 and the protruding portion 124. The glue bulk 150 is filled in the glue trough 114, and the glue bulk 150 is able to fully seal the cable hole from the inner surface of the lower case 110, such that the fed glue will not forms unsightly residues on the outer surface of the lower case 110. In addition, The glue 150 also fixes the electricity cable 130 by wrapping the electricity cable 130, so that the electricity cable 130 can withstand the pulling force and prevent the internal end 132 from falling off the connected circuit.

As shown in FIG. 6 and FIG. 7, the pressing block 120 includes two embedding wings 125 arranged opposite to each other and extending from edges of the rear side surface 122. The lower case 110 further includes two embedding grooves 117 arranged opposite to each other and located at the notch 113, and the embedding wings 125 are configured to be embedded into the embedding grooves 117 respectively. The combination of the embedding wings 125 and the embedding grooves 117 extends the depth of the joint between the lower case 110 and the pressing block 120 to reduce the probability of water leakage. The combination also prevents the pressing block 120 from falling off.

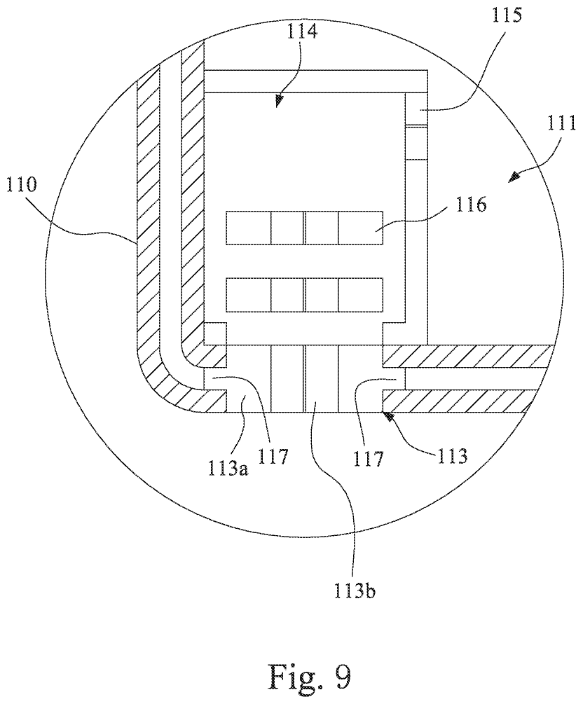

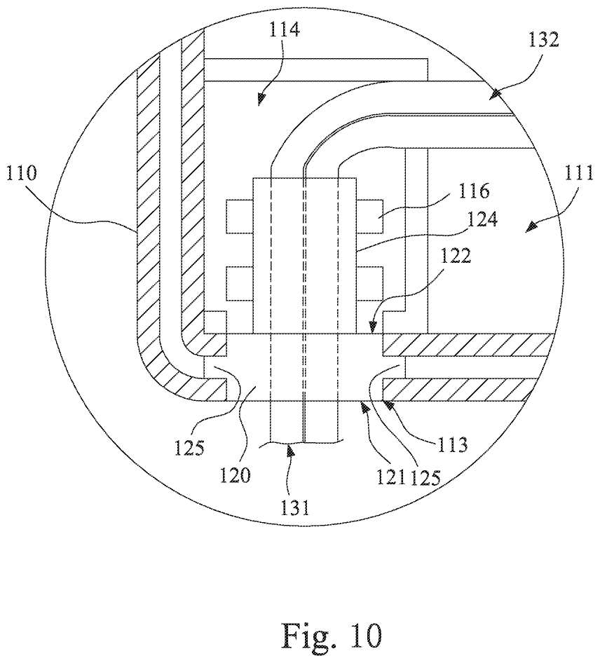

As shown in FIG. 9 and FIG. 10, in some embodiments of this disclosure, the two embedding wings 125 are located between the front side surface 121 and the rear side surface 122, and the lower case 110 further includes two embedding grooves 117 arranged opposite to each other and located at the notch 113, and the embedding wings 125 are configured to be embedded into the embedding grooves 117 respectively.

As shown In FIG. 2 and FIG. 8, the box 100 with waterproof cable hole structure further includes a sealant ring 160 arranged to surround the opening and to be pressed between the upper cover 140 and the lower case 110. The upper cover 140 further includes a collar 141 configured to press the sealant ring 160, so as to enhance the waterproof effect between the lower case 110 and the upper cover 140. In the actual assembling process, after the pressing block 120 is embedded into the notch 113 to press the electricity cable 130, the sealant ring 160 is then installed to the opening 112 of the lower case 110.

In this disclosure, the electricity cable 130 can be easily placed in the notch 113. And then the pressing block 120 is embedded into the notch 113 to press the electricity cable 130. The electricity cable 130 and the inner wall of the cable hole can contact each other to achieve a good waterproof effect. Therefore, it is not required to dispense glue on the outside of the lower case 110 to affect the appearance of the box. And the configuration of the above structure is conducive to the rapid production of automated machinery. In at least one embodiment, the lower case 114 is provided with a glue trough for filling the glue bulk 150, the glue bulk 150 further seals the cable hole from the inside of the lower case 100, and at the same time the glue bulk 150 further fixes the electricity cable 130, so that the electricity cable 130 is able to withstand pulling force.

What is claimed is:

1. A box with waterproof cable hole structure, comprising:
a lower case, including an accommodating space and an opening connecting the accommodating space; wherein a notch is formed on an edge of the opening, the notch has a lower pressing surface in parallel to the edge of the opening, and a lower cable groove is formed on the lower pressing surface and connects the accommodating space and an outer surface of the lower case;
a pressing block, configured to be embedded into the notch, wherein the pressing block includes a front side surface and a rear side surface respectively corresponding to the outer surface and the accommodating space, the pressing block further includes an upper pressing surface configured to combined with the lower pressing surface, and the upper pressing surface includes an upper cable groove configured to combined with the lower cable groove to form a cable hole;
an electricity cable including an external end and an internal end; wherein the electricity cable passes through the cable hole and is pressed between the upper pressing surface and the lower pressing surface, the internal end is located within the accommodating space and the external end is located outside the lower case; and
an upper cover, configured to be combined with the lower case to seal the opening.

2. The box with waterproof cable hole structure according to claim 1, further comprising: a glue bulk, partially filled in the accommodating space and covering a connection between the electricity cable and the cable hole.

3. The box with waterproof cable hole structure according to claim 2, wherein the lower case further includes a glue trough located in the accommodating space and surrounding the connection between the electricity cable and the cable hole, and the glue bulk is filled in the glue trough.

4. The box with waterproof cable hole structure according to claim 3, wherein the lower case further includes an auxiliary cable groove located on an edge of the glue trough, for hanging the electricity cable thereon, such that the internal end is located outside the glue trough.

5. The box with waterproof cable hole structure according to claim 3, wherein the lower case further includes a cable seat disposed in the glue trough, the pressing block further a protruding portion protruding from the rear side surface, and the protruding portion is configured to press the electricity cable on the cable seat.

6. The box with waterproof cable hole structure according to claim 1, wherein the pressing block includes two embedding wings arranged opposite to each other and extending from edges of the rear side surface.

7. The box with waterproof cable hole structure according to claim 6, wherein the lower case further includes two embedding grooves arranged opposite to each other and located at the notch, and the embedding wings are configured to be embedded into the embedding grooves respectively.

8. The box with waterproof cable hole structure according to claim 1, wherein the pressing block includes two embedding wings arranged opposite to each other and located between the front side surface and the rear side surface, the lower case further includes two embedding grooves arranged opposite to each other and located at the notch, and the embedding wings are configured to be embedded into the embedding grooves respectively.

9. The box with waterproof cable hole structure according to claim 1, further comprising: a sealant ring, arranged to surround the opening and to be pressed between the upper cover and the lower case.

10. The box with waterproof cable hole structure according to claim 9, wherein the upper cover further includes a collar configured to press the sealant ring.
